(19) United States
(12) Patent Application Publication
(10) Pub. No.: US 2026/0058463 A1
(43) Pub. Date: Feb. 26, 2026

(54) DISTRIBUTED POWER MANAGEMENT SYSTEM FOR DC MICROGRID UNDER DOS AND FDI ATTACKS

(71) Applicant: FOUNDATION FOR RESEARCH AND BUSINESS, SEOUL NATIONAL UNIVERSITY OF SCIENCE AND TECHNOLOGY, Seoul (KR)

(72) Inventors: Kyeong-Hwa KIM, Seoul (KR); Thanh Dat TRAN, Seoul (KR)

(73) Assignee: FOUNDATION FOR RESEARCH AND BUSINESS, SEOUL NATIONAL UNIVERSITY OF SCIENCE AND TECHNOLOGY, Seoul (KR)

(21) Appl. No.: 19/051,184

(22) Filed: Feb. 12, 2025

(30) Foreign Application Priority Data
Aug. 21, 2024 (KR) 10-2024-0112162

(51) Int. Cl. H02J 1/10; H04L 9/40

(52) U.S. Cl. CPC H02J 1/10; H04L 63/1458

(57) ABSTRACT

A distributed power management system for a DC microgrid against DoS and FDI attacks, includes a utility grid agent for injecting power to a DC bus or absorbing excess power from the DC bus, a wind turbine agent for only supplying power to the DC bus, an electric vehicle agent and a battery agent for supplying power to the DC bus or absorbing excess power from the DC bus, and a load agent for only consuming power from the DC bus, wherein the utility grid agent, the wind turbine agent, the electric vehicle agent, and the battery agent are equipped with a distributed secondary control (DSC) module, a primary control module is used to maintain power balance, the secondary control module is used to maintain voltage restoration, and a compensation term is incorporated into the DSC module to eliminate unbounded FDI attacks and DoS attacks.

### CROSS REFERENCE TO RELATED APPLICATION

This application claims priority to Korean Patent Application No. 10-2024-0112162 filed Aug. 21, 2024, which is all hereby incorporated by reference in its entirety.

### ACKNOWLEDGEMENT

This research was supported by Basic Science Research Program through the National Research Foundation of Korea (NRF) funded by the Ministry of Education (NRF-2019R1A6A1A03032119).

### BACKGROUND

The present disclosure relates to a distributed power management system for a DC microgrid (DCMG). More particularly, the present disclosure relates to a distributed power management system for a DC microgrid under DoS and FDI attacks, the system being capable of achieving power balance and voltage restoration under the uncertainty of a renewable energy source (RES), an electric vehicle (EV), an energy storage system (ESS), a utility grid system, and load power, and being capable of improving the robustness and reliability of a distributed DCMG system even under unbounded false data injection (FDI) and denial-of-service (DoS) attacks.

Today, rapid industrialization and development of modernization in the world have increased the global electricity demand. To achieve balance between energy development and environmental protection, a microgrid system, which generally consists of a utility grid, renewable energy source (RES), an energy storage system (ESS), and a load, has been widely studied for future power systems. This microgrid system consists of two main categories: an AC microgrid (ACMG) and a DC microgrid (DCMG). The DCMG has received more attention from researchers than the ACMG due to its superior system efficiency, high power quality, and controller simplicity.

According to the connectivity of a utility grid, DCMG operation is divided into grid-connected operation (GCO) and islanded operation (IO). In grid-connected operation, generally, a utility grid agent regulates power exchange to achieve power management and voltage restoration of a DCMG system. In order to minimize the operation cost of the DCMG system under grid-connected operation, it is necessary to consider the optimal power consumption of the utility grid agent. On the other hand, in islanded operation, it is necessary for power agents of the DCMG system to cooperate effectively to ensure power sharing even in abnormal or uncertain situations including a state-of-charge (SOC) risk level of the energy storage system, and sudden power fluctuations of the power agents. Therefore, a control method for improving overall DCMG operation efficiency in both grid-connected operation (GCO) and islanded operation (IO) has been proposed.

Control strategies of the DCMG system are classified into a centralized strategy, a decentralized strategy, and a distributed strategy on the basis of a communication point of view. Conventionally, the centralized strategy uses a central controller to collect information of all power agents through a digital communication link (DCL) and provide optimal power management. However, there are many weak points, such as computational burden, flexibility, and a single point of failure due to the central controller. In contrast, the decentralized strategy uses only the local sensors of the power agents of the DCMG system to individually determine appropriate operation to ensure power balance without the DCL. Although the decentralized method improves scalability and reduces system cost, it is very difficult to maintain the stability of the entire DCMG system under uncertainty, such as agent power fluctuations, due to the lack of information exchange between the power agents. To overcome this weak point, the distributed strategy is considered to be an effective strategy because unlike the centralized strategy, only information from adjacent power agents is used for the stability of the entire DCMG system.

In the meantime, Korean Patent No. 10-2549305 discloses “MICROGRID SYSTEM AND METHOD OF CONTROLLING THEREOF”. The microgrid system includes: a distributed power source for generating power by using renewable energy as an energy source; a plurality of energy storage systems connected to the distributed power source to form a microgrid, and configured to store power supplied from the distributed power source or output pre-stored power to outside; and a central controller for controlling the distributed power source and the plurality of energy storage systems. The central controller is configured to set any one of the plurality of energy storage systems as a master device, and set the remaining energy storage systems as slave devices. The master device is configured to output a constant voltage and a constant frequency in a normal state, and change the output frequency in the normal state to another value within a preset tolerance range when an overload is applied. The central controller is configured to, when active power applied to the master device is distributed through frequency-active power droop control for the slave devices, instruct the slave devices for a new active power reference value to return an output frequency change value of the master device to an output frequency value in the normal state.

In the above-described patent document, a plurality of energy storage systems are used and failures occurring in the energy storage systems in operation are quickly detected and dealt with, so that a power failure can be prevented in a small-scale power system by using the energy storage systems a base power source, thereby supplying electricity with superior power quality. However, a centralized control method is used as a control method, and this involves various problems, such as computational burden, flexibility, and a single point of failure.

### SUMMARY

The present disclosure is directed to providing a distributed power management system for a DC microgrid under DoS and FDI attacks, wherein each agent of a utility grid, a wind turbine, an electric vehicle, and a battery is equipped with a distributed secondary control (DSC) means, the primary control is used to maintain power balance while the secondary control is used to maintain voltage restoration, a means for eliminating unbounded false data injection (FDI) attacks and denial-of-service (DoS) attacks is provided, so that power balance and voltage restoration can be achieved under the uncertainty of a renewable energy source (RES), an electric vehicle (EV), an energy storage system (ESS), a power system (utility grid), and load power. The robustness and reliability of a distributed DCMG system can be improved even under unbounded FDI and DoS attacks.

According to the present disclosure, there is provided a distributed power management system for a DC microgrid against DoS and FDI attacks, the distributed power management system including:
a utility grid agent configured to inject power into a DC bus or absorb excess power from the DC bus through a transformer and a bi-directional AC/DC converter;
a wind turbine agent configured to convert mechanical energy into electrical energy, and only supply power to the DC bus through a permanent magnet synchronous generator (PMSG) and a uni-directional AC/DC converter;
an EV agent configured to use a bi-directional interleaved DC/DC converter to supply power to the DC bus or absorb excess power from the DC bus;
a battery agent configured to use a bi-directional interleaved DC/DC converter to supply power to the DC bus or absorb excess power from the DC bus; and
a load agent configured to only consume power from the DC bus,
wherein the utility grid agent, the wind turbine agent, the EV agent, and the battery agent are equipped with a distributed secondary control (DSC) module. The primary control module is used to maintain power balance while the distributed secondary control module is used to maintain voltage restoration, and a compensation term is incorporated into the DSC module to eliminate unbounded false data injection (FDI) attacks and denial-of-service (DoS) attacks.

Herein, the utility grid agent may be configured to automatically change voltage-power (V*-P) droop curve to optimize electricity consumption under changes in electricity charge.

In addition, only five digital communication links (DCLs) may be installed between the utility grid agent, the wind turbine agent, the EV agent, the battery agent, and the load agent for data exchange between the adjacent agents, and the five DCLs may be configured to transmit only distributed secondary control (DSC) output of the power agents.

Herein, among the five DCLs, a first DCL may be allocated to transmit data from the utility grid agent to the wind turbine agent, a second DCL may be allocated to transmit data from the wind turbine agent to the load agent, a third DCL may be allocated to transmit data from the wind turbine agent to the battery agent, a fourth DCL may be allocated to transmit data from the battery agent to the EV agent, and a fifth DCL may be allocated to transmit data from the EV agent to the utility grid agent.

Herein, when the utility grid agent is disconnected in the DCMG, a value of the DSC output may drop to zero and state information may be transmitted to the wind turbine agent to report this situation.

According to the present disclosure, a utility grid, a wind turbine, an electric vehicle, and a battery are equipped with a distributed secondary control (DSC) means. While the primary control is used to maintain power balance, secondary control is used to maintain voltage restoration, and a means for eliminating unbounded false data injection (FDI) attacks and denial-of-service (DoS) attacks is provided, so that power balance and voltage restoration can be achieved under the uncertainty of a renewable energy source (RES), an electric vehicle (EV), an energy storage system (ESS), a power system (utility grid), and load power, and the robustness and reliability of a distributed DCMG system can be improved even under unbounded FDI and DoS attacks.

### BRIEF DESCRIPTION OF THE DRAWINGS

FIG. 1 is a diagram schematically illustrating the configuration of a distributed power management system for a DC microgrid against DoS and FDI attacks, according to an embodiment of the present disclosure.

FIG. 2 is a diagram illustrating the configuration of the distributed secondary control (DSC) module implemented at every power agent of the distributed power management system according to the present disclosure.

FIG. 3 is a diagram illustrating the V*-P droop curve for the distributed DCMG system.

FIGS. 4A, 4B, 4C, and 4D are diagrams illustrating closed-loop eigenvalue maps for a distributed control method applied to the present disclosure under changes in control system parameters and the t∈Π_{N}.

FIG. 5 is a diagram illustrating a simulation result of a grid-connected mode under unbounded FDI and DoS attacks in the case of transmission time delay, electricity price change, and the maximum EV SOC level.

FIG. 6 is a diagram illustrating transition from GCO to IO without cyber attacks in the case of a normal electricity price condition and the maximum SOC_{EV} level, as experimental results for a DCMG system based on a distributed power management system of the present disclosure.

FIG. 7 is a diagram illustrating GCO against DoS and FDI attacks in the case of a high power price condition and the minimum SOC_{EV} level, as experimental results for a DCMG system based on a distributed power management system of the present disclosure.

### DETAILED DESCRIPTION

Hereinafter, an embodiment of the present disclosure will be described with reference to the accompanying drawings.

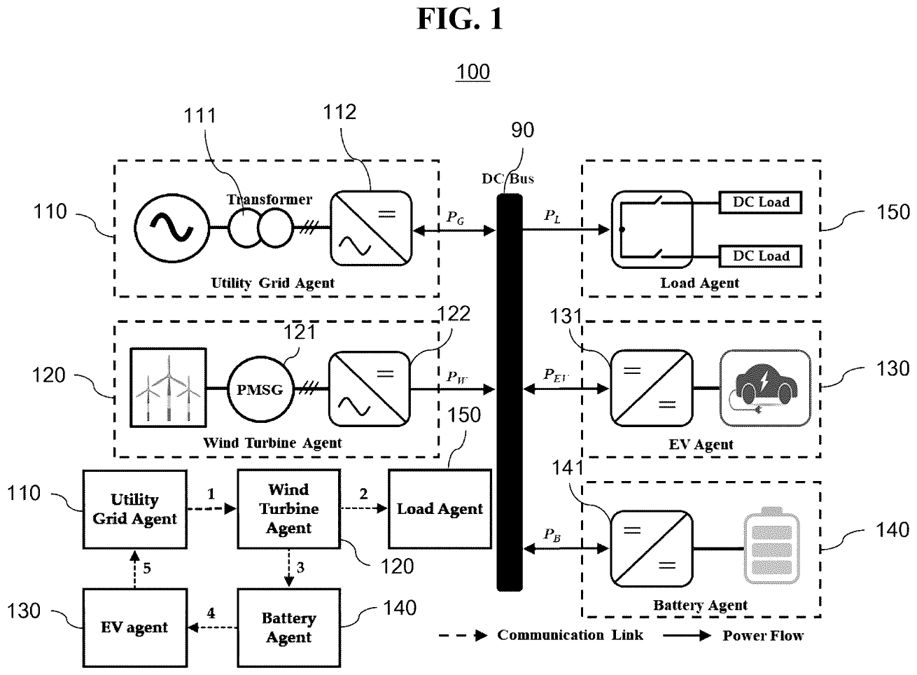

FIG. 1 is a diagram schematically illustrating the configuration of a distributed power management system for a DC microgrid against DoS and FDI attacks, according to an embodiment of the present disclosure.

Referring to FIG. 1, the distributed power management system 100 for the DC microgrid against DoS and FDI attacks according to the present disclosure may include a utility grid agent 110, a wind turbine agent 120, an electric vehicle agent 130, a battery agent 140, and a load agent 150.

The utility grid agent 110 injects power into a DC bus 90 or absorbs excess power from the DC bus 90 through a transformer 111 and a bi-directional AC/DC converter 112. Herein, the utility grid agent 110 may be configured to automatically changes the voltage-power (V*-P) droop curve to optimize electricity consumption under electricity price change.

The wind turbine agent 120 converts mechanical energy into electrical energy, and only supplies power to the DC bus (90) through a permanent magnet synchronous generator (PMSG) 121 and a uni-directional AC/DC converter 122. Herein, the wind turbine agent 120 is provided as an example as part of a renewable energy source (RES), and no limitation to the wind turbine agent 120 is imposed. For example, in some cases, the wind turbine agent may be replaced by a solar power generation agent.

The electric vehicle agent 130 uses a bi-directional interleaved DC/DC converter 131 to supply power to the DC bus 90 or absorb excess power from the DC bus 90.

The battery agent 140 uses a bi-directional interleaved DC/DC converter 141 to supply power to the DC bus 90 or absorb excess power from the DC bus 90.

The load agent 150 only consumes power from the DC bus 90.

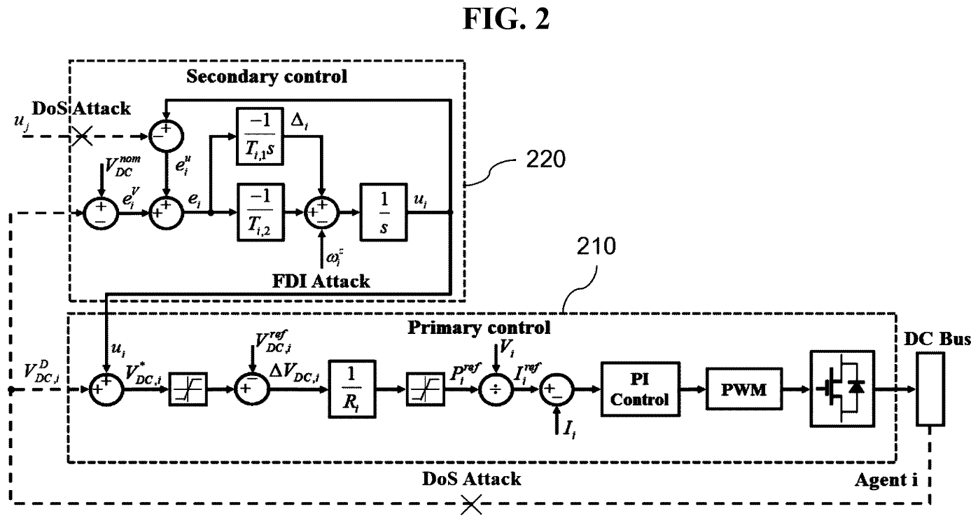

In the distributed power management system 100 for the DC microgrid against DoS and FDI attacks according to the present disclosure having the above configuration, the utility grid agent 110, the wind turbine agent 120, the electric vehicle agent 130, and the battery agent 140 are each equipped with a distributed secondary control (DSC) module 220 as shown in FIG. 2, and a primary control module 210 is used to maintain power balance, the secondary control module 220 is used to maintain voltage restoration, and a compensation term is configured to be incorporated into the DSC module 220 to eliminate unbounded false data injection (FDI) attacks and denial-of-service (DoS) attacks. Herein, the compensation term will be described later.

In addition, for data exchange between adjacent agents, as shown in FIG. 1, only five digital communication links (DCLs) 1˜5 are installed between the utility grid agent 110, the wind turbine agent 120, the electric vehicle agent 130, the battery agent 140, and the load agent 150. Each of the five DCLs 1˜5 may be configured to transmit only distributed secondary control (DSC) output of the power agents (that is, the utility grid agent 110, the wind turbine agent 120, the electric vehicle agent 130, and the battery agent 140).

Herein, among the five DCLs 1˜5, a first DCL 1 may be allocated to transmit data from the utility grid agent 110 to the wind turbine agent 120, a second DCL 2 may be allocated to transmit data from the wind turbine agent 120 to the load agent 150, a third DCL 3 may be allocated to transmit data from the wind turbine agent 120 to the battery agent 140, a fourth DCL 4 may be allocated to transmit data from the battery agent 140 to the EV agent 130, and a fifth DCL 5 may be allocated to transmit data from the EV agent 130 to the utility grid agent 110.

Herein, when the utility grid agent 110 is disconnected in the DCMG, an output value of the DSC module 220 drops to zero and state information is transmitted to the wind turbine agent 120 to report this situation.

In FIG. 1, P_{G} denotes the power of the utility grid agent, P_{L} denotes the power of the load agent, Pw denotes the power of the wind turbine agent, P_{EV} denotes the power of the electric vehicle agent, and P_{B} denotes the power of the battery agent.

Hereinafter, the distributed power management system for the DC microgrid against DoS and FDI attacks according to the present disclosure having the above configuration will be further described.

FIG. 2 is a diagram illustrating the configuration of the distributed secondary control (DSC) module implemented at every power agent of the distributed DCMG system according to the present disclosure.

Referring to FIG. 2, as described above, the primary control module 210 is used to ensure power balance, and the secondary control module 220 is used to maintain voltage restoration.

In the secondary control module 220, the voltage error

$${e}_{i}^{V} ( t )$$

between the nominal DCV (DC link voltage)

$${V}_{D C}^{nom}$$

and the DCV measurement value under DoS attacks

$${V}_{D C , i}^{D} ( t )$$

in the power agent i is calculated as follows.

$${e}_{i}^{V} ( t ) = {∇}_{DC}^{nom} - {V}_{D C , i}^{D} ( t ) \qquad [ Equation 1 ]$$

Under Dos attacks, the voltage

$${V}_{DC , i}^{D} ( t )$$

may be derived using the piecewise function Pᵢ (t) of the power agent i as follows.

$${V}_{DC , i}^{D} ( t ) = {P}_{i} ( t ) {V}_{DC} ( t ) \qquad [ Equation 2 ]$$

Herein, V_{DC} (t) denotes the DCV measurement value.

Equation 2 shows that this is set to the DC bus measurement value

$${V}_{DC , i}^{pre} ( t )$$

before Dos attacks when Dos attacks occur on a DC bus voltage measurement signal of the power agent i. The error

$${e}_{i}^{u} ( t )$$

of the secondary control output between the output uᵢ (t) of the power agent i and the output uⱼ (t) of the power agent j transmitted to the power agent i through the DCL may be represented as follows.

$${e}_{i}^{D u} ( t ) = {u}_{i} ( t ) - {P}_{i} ( t ) {u}_{j} ( t ) ( for the case , j = EV , W , B , G ) \qquad [ Equation 3 ]$$

The combination error

$${e}_{i}^{Du} ( t )$$

of the power agent i under DoS attacks may be obtained as follows.

$${e}_{i}^{D} ( t ) = {α}_{i} {e}_{i}^{DV} ( t ) + {β}_{i} {e}_{i}^{Du} ( t ) \qquad [ Equation 4 ]$$

The compensation term Δᵢ (t) of the power agent i to eliminate FDI attacks in the DSC module 220 may be represented as follows.

$${△}_{i} ( t ) = - {e}_{i}^{D} ( t ) / {T}_{i , 1} \qquad [ Equation 5 ]$$

Herein, T_{i,1} denotes the first auxiliary gain of the power agent i.

The DSC output

$${u}_{i}^{A} ( t )$$

of the power agent i under DoS attacks may be represented as follows.

$${u}_{i}^{A} ( t ) = - ( {e}_{i}^{D} ( t ) / {T}_{i , 2} ) + {△}_{i} ( t ) - {w}_{i}^{z} ( t ) \qquad [ Equation 6 ]$$

$${u}_{i}^{A} ( t ) = {u}_{i}^{cA} ( t ) - {γ}_{i} {e}^{DV} ( t ) \qquad [ Equation 7 ]$$

Herein, T_{i,2} denotes the second auxiliary gain of the power agent i. This equation means that when DoS attacks occur in the power agent i, even an FDI signal cannot be injected into the DSC module 220 through the DCL. Through this, it can be seen that T_{i,1} and T_{i,2} may be used to reduce the voltage deviation between V_{DC} (t) and

$${V}_{DC}^{nom}$$

caused by DoS and FDI attacks.

In the primary control module 210,

$${u}_{i}^{A} ( t )$$

is used to calculate the auxiliary DCV variable

$${V}_{DC , i}^{*} ( t )$$

of the power agent i, and

$${V}_{DC , i}^{*} ( t )$$

may be represented as follows.

$${V}_{DC , i}^{*} ( t ) = {V}_{DC , i} ( t ) + {u}_{i}^{A} ( t ) - {r}_{i} {I}_{i}^{out} ( t )$$

In the present disclosure, the auxiliary DCV variable

$${V}_{DC , i}^{*} ( t )$$

is used to determine the power agent i to ensure power sharing based on the V*-P droop curve.

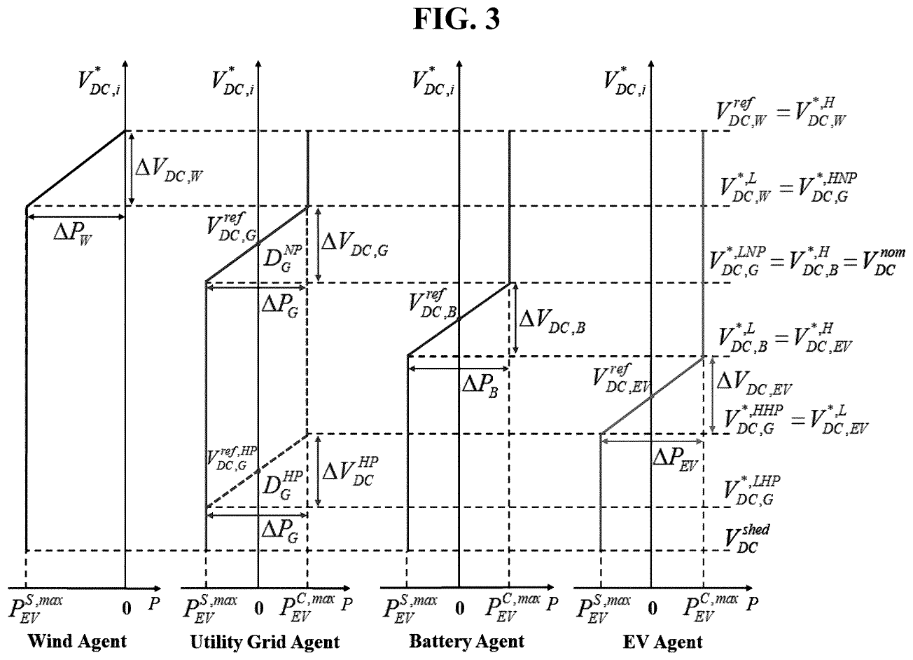

To achieve distributed power management for the DCMG system, FIG. 3 describes the V*-P droop curve of the power agents. The droop curve of the utility grid agent may be adaptively changed to optimize the power absorbed by the DCV.

For example, when the electricity price is normal, the energy supply priorities for the DC bus may be selected in the following order: the wind turbine agent, the utility grid agent, the battery agent, and the EV agent. When the electricity price condition changes from normal to high, the utility grid agent needs to absorb power from the DC bus as much as possible to reduce utility costs. In this case, the utility grid V*-P droop curve may be changed from

$${D}_{G}^{NP} to {D}_{G}^{HP} .$$

### Herein,

$${D}_{G}^{NP} and {D}_{G}^{HP}$$

represent the utility grid droop curves at normal and high power prices, respectively. In this situation, the priorities for energy supply are changed into the wind turbine, battery, electric vehicle, and utility grid agents.

In the primary control module 210, the battery or EV agent operates in an idle mode when the SOC level (SOC_{B}) of the battery agent or the SOC level (SOC_{EV}) of the EV agent reaches the maximum value or the minimum value. When the maximum supply power is less than the load demand of the IO,

$${V}_{DC , i}^{*} ( t )$$

decreases rapidly. To ensure system stability in this emergency situation, a load disconnection mode is activated as soon as the load disconnection threshold voltage

$${V}_{DC}^{shed}$$

is reached according to load priorities. As

$${V}_{DC , i}^{*} ( t )$$

increases to

$${V}_{DC}^{nom} ,$$

load reconnection mode is immediately entered.

In general, most DCMG safety studies only consider either Dos attacks or FDI attacks. To solve this problem, the present disclosure applies a distributed adaptive controller to mitigate mixed DoS and FDI attacks for a uni-directional DC/DC converter. However, for a complex DCMG system consisting of a uni-directional AC/DC converter, a bi-directional AC/DC converter, and a bi-directional DC/DC converter, it is more difficult to achieve the stability of the entire system under both FDI and Dos attacks. In the present disclosure, by introducing DSC based on V*-P droop control, both voltage control and power stability may be ensured under unbounded FDI and DoS attacks and uncertain conditions.

In addition, in the present disclosure, two types of auxiliary gains T_{i,1} and T_{i,2} are used to further reduce the voltage deviation between V_{DC} and

$${V}_{DC}^{nom}$$

caused by cyber attacks.

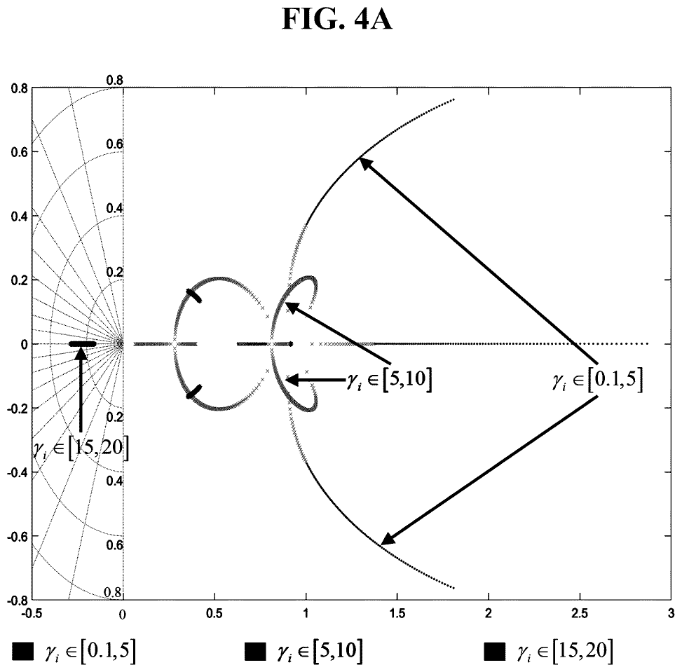

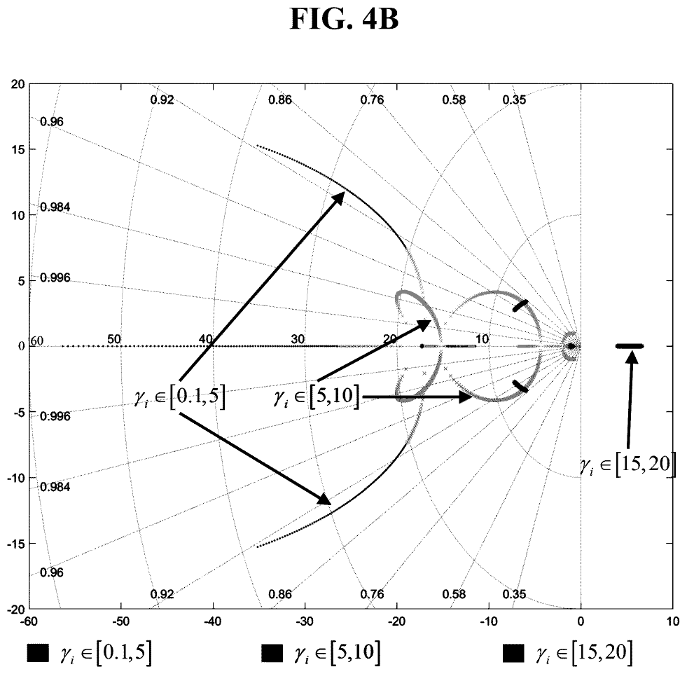

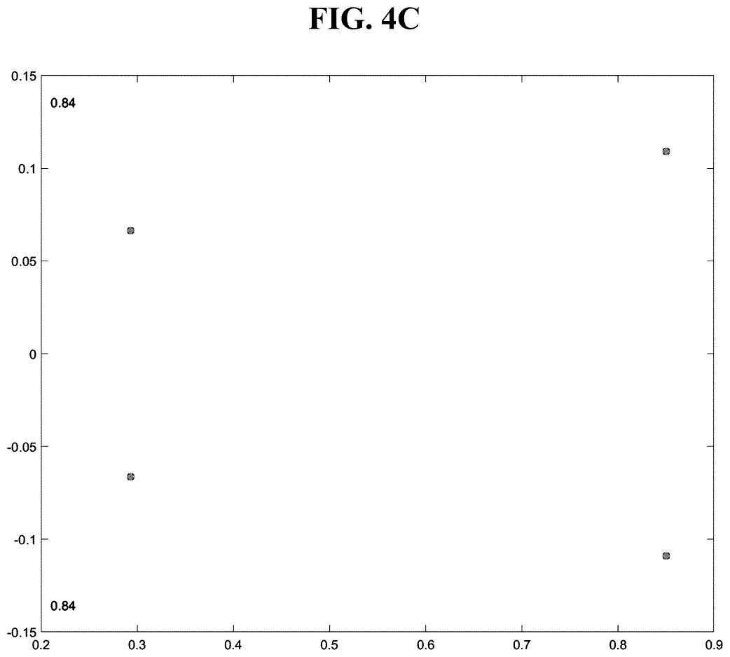

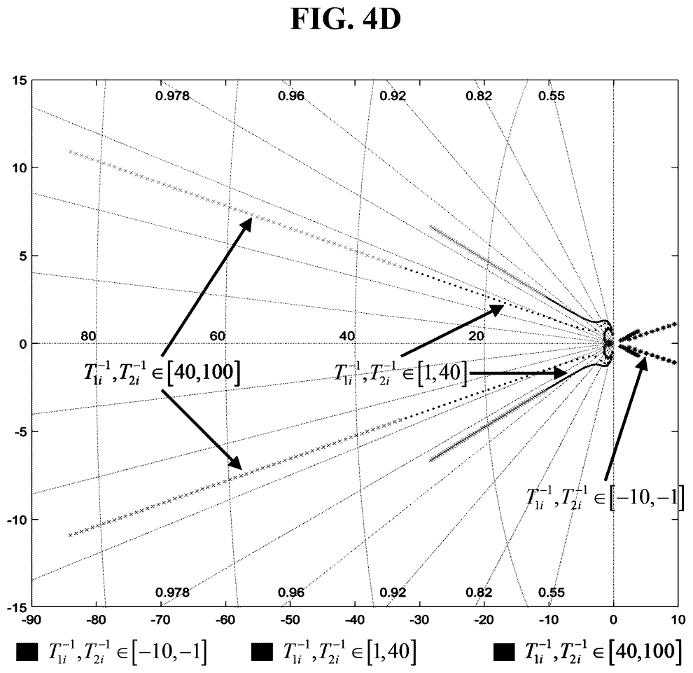

FIGS. 4A, 4B, 4C, and 4D are diagrams illustrating closed-loop eigenvalue maps for a distributed control method applied to the present disclosure under changes in control system parameters and t∈Π_{N}.

FIGS. 4A and 4B show closed-loop eigenvalues of matrixes Z and A, respectively, under t∈Π_{N} in the case of γᵢ∈[0.1;20]. When all eigenvalues of the matrix Z are real numbers greater than 0 (zero) in the case of γᵢ∈[0.1;10], all eigenvalues of the matrix A are positioned to the right of the imaginary axis and the entire distributed DCMG system is stable. As γᵢ increases, all eigenvalues of the matrix A move towards the origin. Thus, the transient time of the distributed DCMG system increases with a smaller overshoot. When eigenvalues of the matrix Z are real numbers less than 0 (zero) in the case of γᵢ∈[15;20], eigenvalues of the matrix A are positioned to the right of the imaginary axis and the entire distributed DCMG system is unstable.

FIGS. 4C and 4D show closed-loop eigenvalues of matrixes Z and A, respectively, under t∈Π_{N} in the case of

$${T}_{1 i}^{- 1} , {T}_{2 i}^{- 1} ∈ [ - 10 , 100 ]$$

in the state of

$${T}_{1 i}^{- 1} = 2 {T}_{2 i}^{- 1} .$$

As shown in FIGS. 4C and 4D, even when eigenvalues state of of the matrix Z are real numbers greater than 0 (zero) in the case of

$${T}_{1 i}^{- 1} , {T}_{2 i}^{- 1} ∈ [ - 10 , 1 ] ,$$

eigenvalues of the matrix A are positioned to the right of the imaginary axis and the entire distributed DCMG system is unstable. In the case of

$${T}_{1 i}^{- 1} , {T}_{2 i}^{- 1} ∈ [ 1 , 100 ] ,$$

all eigenvalues of the matrix A are positioned to the left of the imaginary axis and the entire distributed DCMG system is stable. As

$${T}_{1 i}^{- 1} and {T}_{2 i}^{- 1}$$

increase, all eigenvalues of the matrix A move away from the real axis and the imaginary axis. As a result, the transient time of the system decreases, and the overshoot increases.

In addition, it can be easily seen that all eigenvalues of the matrix Z are βᵢ in the state of t∈Π_{D}. Therefore, the entire distributed DCMG system is stable under both DoS and FDI attacks when βᵢ,

$${T}_{1 i}^{- 1} , and {T}_{2 i}^{- 1}$$

are selected to be values greater than 0 (zero) in the state of γᵢ∈[0.1;10]. Table 1 below summarizes the influence of controller parameters and the unstable region caused by the controller parameters.

TABLE 1

| Control | | Unstable |
|---|---|---|
| parameters | Influence of control parameters | region |
| αᵢ and βᵢ | Increasing αᵢ and βᵢ yields smaller | αᵢ,βᵢ < 0 |
| | transient time and higher overshoot. | |
| γᵢ | Increasing γᵢ yields longer transient | γᵢ ≥ 15 |
| | time and smaller overshoot. | |
| ${T}_{1 i}^{- 1} and {T}_{2 i}^{- 1}$ | $Increasing {T}_{1 i}^{- 1} and {T}_{2 i}^{- 1} yields smaller$ | ${T}_{1 i}^{- 1} , {T}_{2 i}^{- 1} < 0$ |
| | transient time and higher overshoot. | |

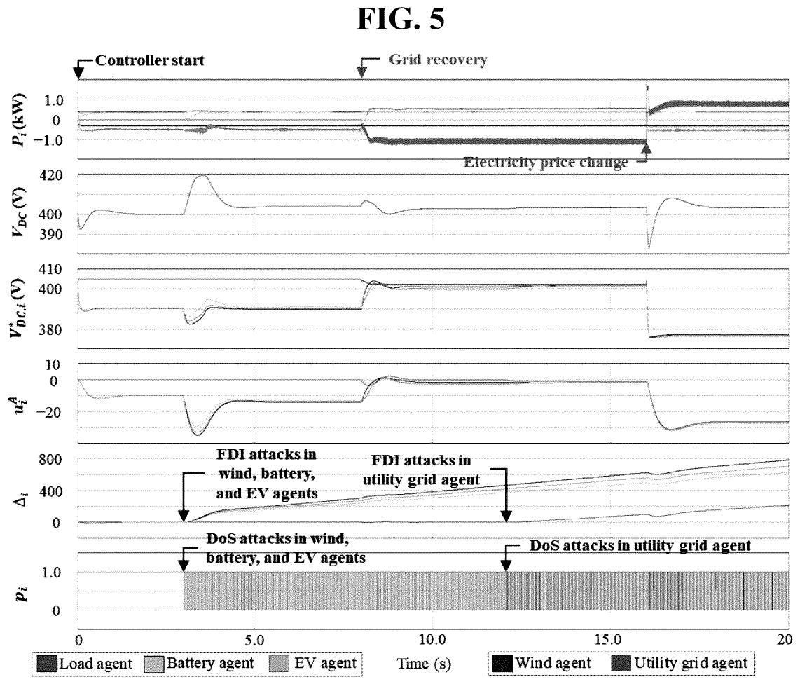

FIG. 5 is a diagram illustrating a simulation result of a grid-connected mode under unbounded FDI and Dos attacks in the case of transmission time delay, electricity price change, and the maximum EV SOC level.

Referring to FIG. 5, this simulation result shows that the strategy (that is, distributed secondary control (DSC)) applied in the present disclosure can still achieve voltage restoration with an acceptable DC-link voltage (DCV) deviation of about 4 V and can ensure control objectives even in the presence of severe cyber attacks and transmission time delay in the DCL and DCV sensors.

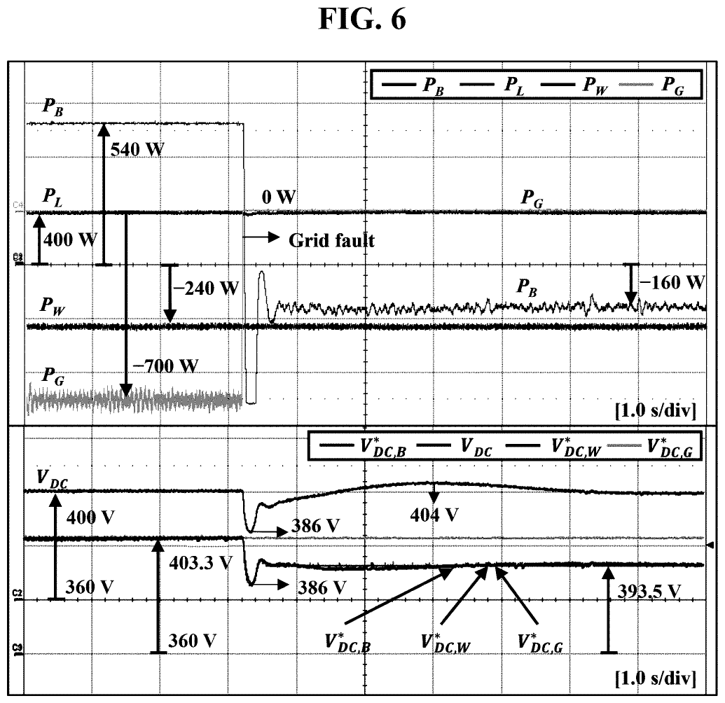

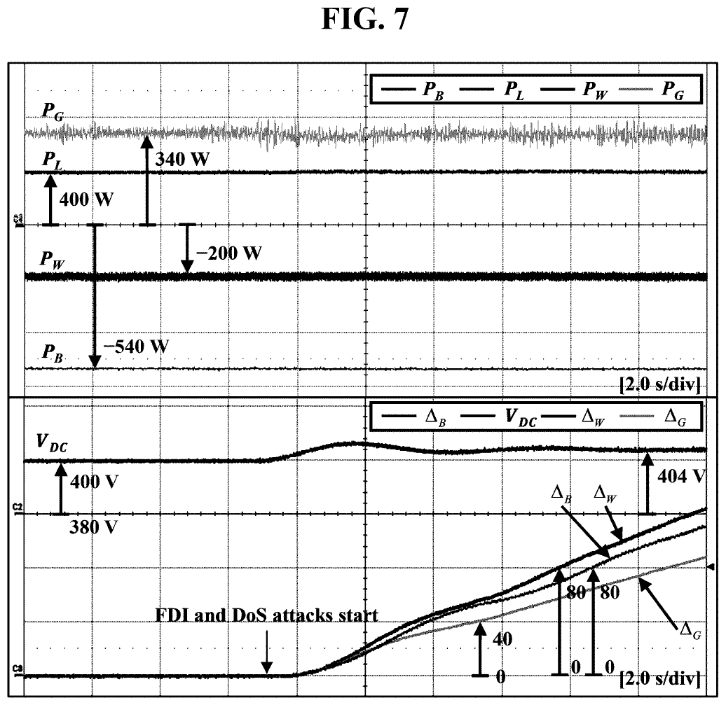

To demonstrate the validity and reliability of the strategy applied in the present disclosure, FIGS. 6 and 7 show experimental results of the distributed DCMG system under various conditions including transition from a grid-connected mode to an islanded mode, maximum SOC_{EV} level, and cyber attacks.

The experimental results in FIG. 6 clearly show that the strategy applied in the present disclosure achieves power management and voltage restoration at nominal values without cyber attacks in both an islanded mode and a grid-connected mode. In addition, in FIG. 7, it can be seen that the distributed DCMG system of the present disclosure effectively achieves power sharing and voltage stability with DCV deviation of only 4 V under severe cyber attacks and an uncertain situation.

The present disclosure proposes a new DSC structure, and according to the technology of the present disclosure, the overshoot of the DCMG can be significantly reduced even under uncertainty conditions, and the DCV can be stably controlled, thereby greatly improving the efficiency of the DCMG. The DSC proposed in the present disclosure requires only a droop controller and a current controller as primary control, and does not require a voltage controller and a current controller in a droop-coupled form as in conventional methods, which can simplify and systematize a control gain tuning process.

As described above, in a distributed power management system for a DC microgrid against DoS and FDI attacks according to the present disclosure, each agent of a utility grid, a wind turbine, an electric vehicle, and a battery is equipped with a distributed secondary control (DSC) means, primary control is used to maintain power balance, secondary control is used to maintain voltage restoration, and a means for eliminating unbounded FDI and DoS attacks is provided, so that power balance and voltage restoration can be achieved under the uncertainty of a renewable energy source (RES), an electric vehicle (EV), an energy storage system (ESS), a utility grid, and load power, and the robustness and reliability of a distributed DCMG system can be improved even under unbounded FDI and DoS attacks.

Although an exemplary embodiment of the present disclosure has been described in detail, the present disclosure is not limited thereto, and it is obvious to those skilled in the art that various modification and applications can be made within the scope of the technical idea of the present disclosure. Accordingly, the true scope of the present disclosure should be interpreted by the following claims, and all technical ideas within the scope equivalent thereto should be interpreted as being included in the scope of the present disclosure.

1. A distributed power management system for a DC microgrid (DCMG) against DoS and FDI attacks, the distributed power management system comprising:
a utility grid agent configured to inject power into a DC bus or absorb excess power from the DC bus through a transformer and a bi-directional AC/DC converter;
a wind turbine agent configured to convert mechanical energy into electrical energy, and only supply power to the DC bus through a permanent magnet synchronous generator (PMSG) and a uni-directional AC/DC converter;
an electric vehicle (EV) agent configured to use a bi-directional interleaved DC/DC converter to supply power to the DC bus or absorb excess power from the DC bus;
a battery agent configured to use a bi-directional interleaved DC/DC converter to supply power to the DC bus or absorb excess power from the DC bus; and
a load agent configured to only consume power from the DC bus,
wherein the utility grid agent, the wind turbine agent, the EV agent, and the battery agent are equipped with a distributed secondary control (DSC) module, a primary control module is used to maintain power balance, the distributed secondary control module is used to maintain voltage restoration, and a compensation terms is incorporated into the DSC module to eliminate unbounded false data injection (FDI) attacks and denial-of-service (DoS) attacks.

2. The distributed power management system of claim 1, wherein the utility grid agent is configured to automatically change a voltage-power (V-P) droop curve to optimize electricity consumption under electricity price change.

3. The distributed power management system of claim 1, wherein only five digital communication links (DCLs) are installed between the utility grid agent, the wind turbine agent, the EV agent, the battery agent, and the load agent for data exchange between the adjacent agents, and the five DCLs are configured to transmit only distributed secondary control (DSC) output of the power agents.

4. The distributed power management system of claim 3, wherein among the five DCLs, a first DCL is allocated to transmit data from the utility grid agent to the wind turbine agent, a second DCL is allocated to transmit data from the wind turbine agent to the load agent, a third DCL is allocated to transmit data from the wind turbine agent to the battery agent, a fourth DCL is allocated to transmit data from the battery agent to the EV agent, and a fifth DCL is allocated to transmit data from the EV agent to the utility grid agent.

5. The distributed power management system of claim 3, wherein when the utility grid agent is disconnected in the DCMG, a value of the DSC output drops to zero and state information is transmitted to the wind turbine agent to report this situation.
